(19) United States
(12) Patent Application Publication
(10) Pub. No.: US 2019/0369792 A1
(43) Pub. Date: Dec. 5, 2019

(54) TOUCH DISPLAY MODULE AND DISPLAY DEVICE

(71) Applicant: WUHAN CHINA STAR OPTOELECTRONICS TECHNOLOGY CO., LTD., Wuhan, HB (CN)

(72) Inventor: Tengteng Shi, Wuhan (CN)

(21) Appl. No.: 16/300,056

(22) PCT Filed: Sep. 22, 2018
(86) PCT No.: PCT/CN2018/107150

§ 371 Date: Nov. 8, 2018

(30) Foreign Application Priority Data
May 30, 2018 (CN) 201810542314.2

(51) Int. Cl. G06F 3/041

(52) U.S. Cl. CPC G06F 3/0414; G06F 2203/04103

(57) ABSTRACT

The invention provides a touch display module and display device. The touch display module comprises: a patterned piezoelectric film layer, a lead wire layer, and a force controller; the piezoelectric film layer feeding back an electrical signal according to a sensed force; the lead wire layer provided with lead wires to deliver the electrical signal to the force controller, the force controller disposed at periphery of active area of the touch display module, configured to determine force touch information according to the electrical signal. The invention also provides a display device using the above touch display module. The touch display module and the display device of the invention integrate the force touch function into the touch display module, thereby improving the screen body integration, making the terminal thinner and lighter, reducing overall cost, and improving the terminal reliability of the force touch function to provide users with better experience.

### BACKGROUND OF THE INVENTION

### 1. Field of the Invention

The present invention relates to the field of display, and in particular to a touch display module and display device.

### 2. The Related Arts

With the rapid development of touch display technology, the end users put forward higher requirements on the touch display device, and demand the touch display device to be thinner, providing higher resolution, and integrating more functions into the terminal devices, wherein the terminal devices integrated with force touch function have gained certain recognition in the market with the launch of the iPhone. The force touch technology has begun to be gradually applied to terminal devices such as mobile phones and tablets.

At present, most of the force touch functions commonly used in the market are realized by capacitive means or other means, but the majority is related to the middle frame of the terminal devices, which leads to, when performing the implementation of the reliability experiment, the structure of the terminal device will affect the implementation of the force touch function, which is also a factor hindering the promotion of force touch function.

### SUMMARY OF THE INVENTION

The object of the present invention is to provide a touch display module and display device, able to integrate the force function to the touch display module.

To achieve the above object, the present invention provides a touch display module, which comprises: a patterned piezoelectric film layer, a lead wire layer, and a force controller; the piezoelectric film layer feeding back an electrical signal according to a sensed force; the lead wire layer being provided with lead wires to deliver the electrical signal to the force controller, the force controller being disposed at a periphery of an active area of the touch display module, and being configured to determine force touch information according to the electrical signal.

Wherein, the piezoelectric film layer is patterned to form a plurality of electrodes.

Wherein, a touch module of the touch display module is an external touch module, and the piezoelectric film layer is disposed in a display module of the touch display module; the electrodes are used as electrodes for force sensors and electrodes for grounding.

Wherein, the piezoelectric film layer is divided into six regions; five regions are respectively located at the center and four corners of the active area, and the five regions respectively form five electrodes of force sensors, and the remaining region forms an electrode connected to the ground.

Wherein, the lead wire is connected to the electrode of the force sensor.

Wherein, the touch module of the touch display module is an in-cell touch module, and power supply voltage of the electrode is consistent with power supply voltage of a touch pad of the in-cell touch module.

Wherein, the piezoelectric film layer is entirely a grid structure, and the grid of the piezoelectric film layer corresponds to pixel units.

Wherein, the force controller is packaged on a flexible circuit board in a chip on film (COF) manner, and the flexible circuit board and the lead wire are connected together via a bonding pad.

Wherein, the touch display module further comprises: a protective layer, an optical adhesive/optical resin layer, and a cover lens; the piezoelectric film layer, the protective layer, the lead wire layer, the optical adhesive/optical resin layer, and the cover lens are sequentially stacked on the display module of the touch display module; or the optical adhesive/optical resin layer, the lead wire layer, the piezoelectric film layer, the protective layer, and the cover lens are sequentially stacked on the display module of the touch display module.

Wherein, the display module is a liquid crystal display (LCD) module.

Wherein, the display module is an organic light-emitting diode (OLED) display module.

The present invention also provides a display device comprising the touch display module of any of the above.

In summary, the touch display module and the display device of the present invention integrate the force touch function into the touch display module, thereby improving the integration of the screen body, making the terminal device thinner and lighter, reducing the overall cost of the module, and improving the terminal device reliability of the force touch function to provide users with a better experience.

### BRIEF DESCRIPTION OF THE DRAWINGS

To make the technical solution of the embodiments according to the present invention, a brief description of the drawings that are necessary for the illustration of the embodiments will be given as follows. Apparently, the drawings described below show only example embodiments of the present invention and for those having ordinary skills in the art, other drawings may be easily obtained from these drawings without paying any creative effort. In the drawings:

FIG. 1 is a schematic view showing the touch display module of the first embodiment the present invention;

FIG. 2 is a cross-sectional view showing the CF side structure of the first embodiment of the present invention;

FIG. 3 is a schematic view showing the lead wire of the first embodiment of the present invention;

FIG. 4 is a cross-sectional view showing the touch display module of the second embodiment of the present invention;

FIG. 5 is a schematic view showing the operation flow of the piezoelectric film layer of the touch display module of the present invention.

### DETAILED DESCRIPTION OF THE PREFERRED EMBODIMENTS

To further explain the technical means and effect of the present invention, the following refers to embodiments and drawings for detailed description.

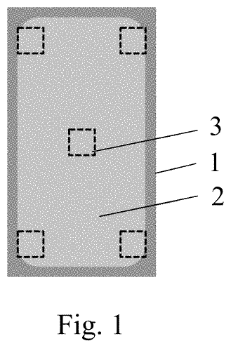

Refer to FIG. 1. FIG. 1 is a front view showing the touch display module of the first embodiment the present invention. The active area 2 of the touch display module is disposed in the range of a peripheral contour 1, and the dotted square area 3 in the active area 2 represents the position of the piezoelectric film electrode as a force sensor, and the force touch function is realized by the force sensor within the range of the active area 2. In view of the problems of the prior art, the present invention integrates the force touch function into the display module in the touch display module or other positions, and is not associated with the middle frame of the whole machine, thereby avoiding the problem of reliability.

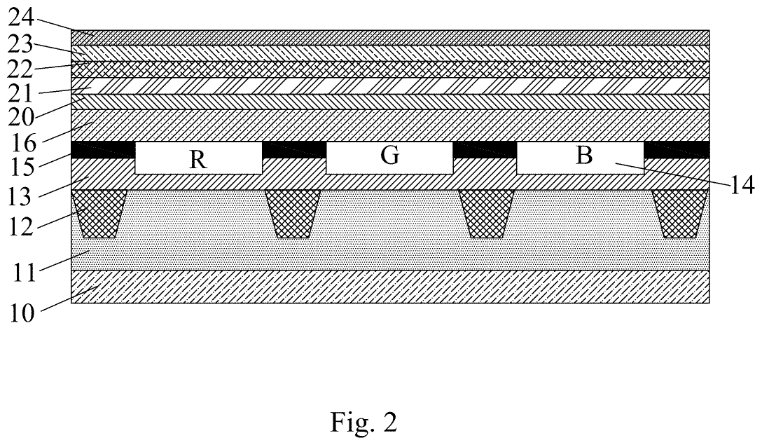

Refer to FIG. 2, which is a cross-sectional view showing the CF side structure of the first embodiment of the present invention. The touch display module of the first embodiment of the present invention mainly comprises: a display module, a piezoelectric film layer 20, a protective layer (OC) 21, a lead wire layer 22, and an optical adhesive (OCA)/optical resin (OCR) layer 23 and a cover lens 24 disposed on the display module in sequence; wherein the display module can be a liquid crystal display (LCD) module, or other types of display modules, such as an OLED display module. The present invention specifically uses an LCD module as an example for explanation.

The present invention integrates the force touch function into the display module in the touch display module, and the structure for implementing the force touch function mainly comprises: the patterned piezoelectric film layer 20, the lead wire layer 22, and a force controller (not shown). The piezoelectric film layer 20 can be patterned to form a plurality of electrodes, wherein some or all of the electrodes can be used as a force sensor, so that the piezoelectric film layer 20 can feed back an electrical signal according to the sensed force. The lead wire layer 22 is disposed with a lead wire for transmitting the foregoing electrical signal to the force controller, and lead wire is used to connect the electrode as the force sensor with the force controller. The force controller can be disposed in the periphery of the active area on the touch display module and can determine the force touch information according to the electrical signal, comprising the number of force points applied, the position of the point, and the magnitude of the applied force, and so on.

In the present invention, by adding a piezoelectric film layer 20 to the existing touch display module, when a force is applied to the display panel, the piezoelectric film layer 20 feeds back an electrical signal to the force controller. By patterning the piezoelectric film layer 20 in advance, the entire touch display module can sense the number of force points, point position, and force applied to the module within a certain range.

When fabricating the touch display module of the present invention, a display module comprising a TFT array substrate 10, a liquid crystal layer (LC) 11, a spacer 12, a protective layer 13, a color-resist 14, a black matrix (BM) 15, and a glass substrate 16 can be formed. Then, on the display module, a piezoelectric film material is plated on the back side of the color film (CF) substrate to form a piezoelectric film layer 20, and a layer of insulating material is coated on the piezoelectric film layer 20 to form a protective layer (for planarization effect) 21, a lead wire layer 22, an optical adhesive/optical resin layer 23, and a cover lens 24 are prepared. The piezoelectric film material of the piezoelectric film layer 20 generates a current when the force is sensed, and a plurality of electrodes are formed by patterning the piezoelectric film material, comprising the electrodes as pressure sensors. After a certain degree of force is sensed, depending on the magnitude of the force, a current of different magnitude is fed back to the force controller connected to the periphery, so that the magnitude of the force can be determined according to the current magnitude in each region. The operating principle can be seen in FIG. 5. The position of the lead wire layer 22 in FIG. 2 is not unique in the stacked structure and can be changed depending on the actual situation.

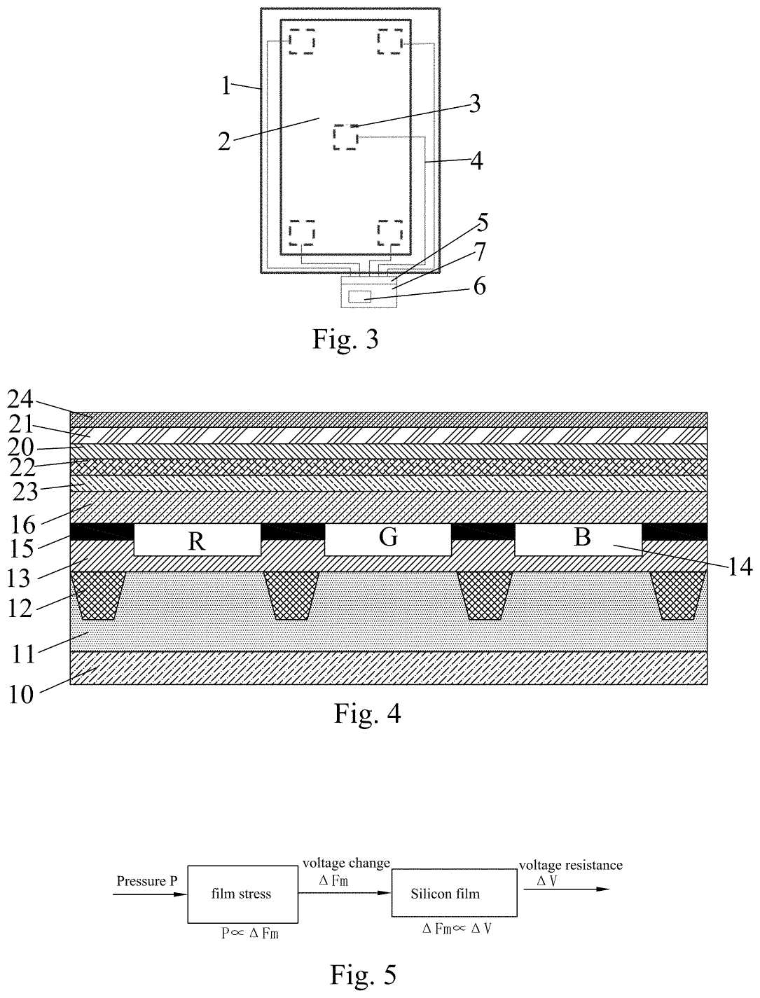

Refer to FIG. 3, which is a schematic view showing the lead wire of the first embodiment of the present invention. The active area 2 is disposed in the peripheral contour 1 of the touch display module, and a dotted square area 3 in the effective display area 2 represents the position of the piezoelectric film electrode as a pressure sensor. For the patterning processing of the piezoelectric film layer, the present invention provides a processing method as an example, but the processing method is not unique, and the piezoelectric film layer processed by this processing method can detect the force at a single point. The processing manner is as shown in FIG. 3, dividing the entire area of piezoelectric film layer into six regions, including five dotted square regions 3 located at the center and four corners of the active area 2, and the piezoelectric film electrode at the position of the dotted square region 3 can form an electrode as a force sensor, and the electrode formed by the piezoelectric film layer of the remaining region is connected to the ground (GND) and can be used as a mask layer. When a finger presses, the force sensor near the pressed point will withstand a larger pressure, resulting in a larger current. According to the different current (voltage) of each force sensor of the five force sensors, the magnitude of the force that the force sensor is subjected to can be calculated, and the pressing position and the force on the screen can be estimated.

As shown in FIG. 3, one end of the lead wire 4 of the lead wire layer is connected to the force sensor at the position of the dotted square region 3, and the other end is connected to a bonding pad 5 at the periphery. The force controller 6 is packaged on a flexible circuit board 7 in a COF manner, and the flexible circuit board 7 and the lead wire 4 are connected together via the bonding pads 5. The routing of the lead wire 4 is not unique, and a simple example is shown in FIG. 3.

Refer to FIG. 4, which is a cross-sectional view showing the touch display module of the second embodiment of the present invention. The optical adhesive/optical resin layer 23, the lead wire layer 22, the piezoelectric film layer 20, the protective layer 21, and the cover lens 24 are sequentially stacked on the display module, and the display module has a structure identical to the display module in FIG. 2. In the second embodiment, the force touch function is integrated on the cover lens 24. A piezoelectric film material is plated on the cover lens 24 to form the piezoelectric film layer 20. In this case, the cover lens 24 is exemplified by a cover glass. A protective layer 21 (for planarization effect) is formed on the back surface of the cover glass, and a piezoelectric film material is coated on the protective layer 21 to form a piezoelectric film layer 20, which generates a current when the force is sensed, and a plurality of electrodes are formed by patterning the piezoelectric film material, comprising the electrodes as pressure sensors. After a certain degree of force is sensed, depending on the magnitude of the force, a current of different magnitude is fed back to the force controller connected to the periphery, so that the magnitude of the force can be determined according to the current magnitude in each region. The operating principle of the first embodiment and the second embodiment is similar, except that the location of the piezoelectric film layer 20 is different. The position of the lead wire layer 22 in FIG. 4 is not unique in the stacked structure and can be changed depending on the actual situation.

In the structures of the first embodiment and the second embodiment, since the piezoelectric film layer has a region connected to the ground, in order to avoid affecting the touch signal of the touch module, the piezoelectric film layer can only be combined with the display module. In the display module, the external touch module and the corresponding display module are combined to form a corresponding touch display module, and for the external touch module, similar to the piezoelectric film layer of the first embodiment and the second embodiment, also has the advantage of eliminating the mask layer.

The present invention also provides an optimization approach that enables the corresponding piezoelectric film layer to be selectively integrated into an in-cell touch module. First, the electrodes formed by the piezoelectric film layer have the same power supply voltage, for example, consistent with the voltage of the touch pad of the in-cell touch module, and the shape and number of the electrodes can be implemented according to the configuration of the first embodiment and the second embodiment. Second, the entire piezoelectric film layer is patterned into a grid structure, no voltage difference exists between the touch electrical signal and the electrode of the piezoelectric film layer, and no power line is formed, and the touch electrical signal can be transmitted through the grid. The grid can be disposed to correspond to the pixel unit of the display panel, for example, one-to-one correspondence, thereby avoiding moiré pattern.

The present invention also provides a display device comprising the above touch display module. The advantages effects of the touch display module and the display device of the present invention comprise: improving user experience; improving integration; reducing material cost; adding added value; improving touch reliability; improving touch performance.

Refer to FIG. 5, which is a schematic view showing the operation flow of the piezoelectric film layer of the touch display module of the present invention. Due to the pressure P ∝ stress ΔFm, the pressure P generated by the touch film is first converted into the film stress ΔFm by the film; due to the film stress ΔFm ∝ voltage change ΔV, the film stress ΔFm can be converted into a voltage change ΔV by the characteristics of the piezoresistive material, and thus the electrode formed by the piezoelectric film layer can be used as a force sensor. Using the force sensor formed by the piezoelectric film layer, the pressure P is converted into a voltage change ΔV, and the corresponding electrical signal can be fed back to the force controller, and the force controller processes the electrical signal through a preset algorithm to restore the force touch information, which may include the number of force points applied, the position of the applied force, and the magnitude of the applied force.

In summary, the touch display module and the display device of the present invention integrate the force touch function into the touch display module, thereby improving the integration of the screen body, making the terminal device thinner and lighter, reducing the overall cost of the module, and improving the terminal device reliability of the force touch function to provide users with a better experience.

Embodiments of the present invention have been described, but not intending to impose any unduly constraint to the appended claims. Any modification of equivalent structure or equivalent process made according to the disclosure and drawings of the present invention, or any application thereof, directly or indirectly, to other related fields of technique, is considered encompassed in the scope of protection defined by the claim of the present invention.

What is claimed is:

1. A touch display module, comprising: a patterned piezoelectric film layer, a lead wire layer, and a force controller; the piezoelectric film layer feeding back an electrical signal according to a sensed force; the lead wire layer being provided with lead wires to deliver the electrical signal to the force controller, the force controller being disposed at a periphery of an active area of the touch display module, and being configured to determine force touch information according to the electrical signal.

2. The touch display module as claimed in claim 1, wherein the piezoelectric film layer is patterned to form a plurality of electrodes.

3. The touch display module as claimed in claim 2, wherein a touch module of the touch display module is an external touch module, and the piezoelectric film layer is disposed in a display module of the touch display module; the electrodes are used as electrodes for force sensors and electrodes for grounding.

4. The touch display module as claimed in claim 3, wherein the piezoelectric film layer is divided into six regions; five regions are respectively located at the center and four corners of the active area, and the five regions respectively form five electrodes of force sensors, and the remaining region forms an electrode connected to the ground.

5. The touch display module as claimed in claim 3, wherein the lead wire is connected to the electrode of the force sensor.

6. The touch display module as claimed in claim 2, wherein the touch module of the touch display module is an in-cell touch module, and power supply voltage of the electrode is consistent with power supply voltage of a touch pad of the in-cell touch module.

7. The touch display module as claimed in claim 6, wherein the piezoelectric film layer is entirely a grid structure, and the grid of the piezoelectric film layer corresponds to pixel units.

8. The touch display module as claimed in claim 1, wherein the force controller is packaged on a flexible circuit board in a chip on film (COF) manner, and the flexible circuit board and the lead wire are connected together via a bonding pad.

9. The touch display module as claimed in claim 1, wherein the touch display module further comprises: a protective layer, an optical adhesive/optical resin layer, and a cover lens; the piezoelectric film layer, the protective layer, the lead wire layer, the optical adhesive/optical resin layer, and the cover lens are sequentially stacked on the display module of the touch display module; or the optical adhesive/optical resin layer, the lead wire layer, the piezoelectric film layer, the protective layer, and the cover lens are sequentially stacked on the display module of the touch display module.

10. A display device, comprising the touch display module as claimed in claim 1.
